(19) United States
(12) Patent Application Publication
(10) Pub. No.: US 2025/0313122 A1
(43) Pub. Date: Oct. 9, 2025

(54) MULTI-MODE CONTROL OF HYBRID BATTERY PACKS

(71) Applicants: Marium Rasheed, Dearborn, MI (US); Hongjie Wang, North Logan, UT (US); Regan A. Zane, Hyde Park, UT (US)

(72) Inventors: Marium Rasheed, Dearborn, MI (US); Hongjie Wang, North Logan, UT (US); Regan A. Zane, Hyde Park, UT (US)

(73) Assignee: Utah State University, Logan, UT (US)

(21) Appl. No.: 18/800,690

(22) Filed: Aug. 12, 2024

Related U.S. Application Data
(60) Provisional application No. 63/631,930, filed on Apr. 9, 2024.

(51) Int. Cl. B60L 58/13; B60L 58/22; H02J 7/00

(52) U.S. Cl. CPC B60L 58/13; B60L 58/22; H02J 7/00714; B60L 2210/10

(57) ABSTRACT

An energy transfer unit includes a power-dense DC-DC converter for each power-dense battery module of a power-dense battery pack. Each power-dense DC-DC converter is connected to a power-dense battery module of the power-dense battery pack and to an auxiliary bus providing power to an auxiliary load. The energy transfer unit includes an energy-dense DC-DC converter for each energy-dense battery module of an energy-dense battery pack. Each energy-dense DC-DC converter is connected to an energy-dense battery module of the energy-dense battery pack and to the auxiliary bus. The energy transfer unit includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack.

### CROSS-REFERENCES TO RELATED APPLICATIONS

This application claims the benefit of U.S. Provisional Patent Application No. 63/631,930 entitled “MULTI-MODE CONTROL OF HYBRID BATTERY PACKS” and filed on Apr. 9, 2024 for Marium Rasheed, et al., which is incorporated herein by reference.

### GOVERNMENT RIGHTS

This invention was made with government support under Grant No. EEC-1941524 awarded by the National Science Foundation (“NSF”) Advancing Sustainability through Powered Infrastructure for Roadway Electrification (“ASPIRE”) Center. The government has certain rights in the invention.

### FIELD

This invention relates to battery control and more particularly to control of multi-mode control of hybrid battery packs.

### BACKGROUND

The increasing adoption of electric vehicles (“EVs”) has emerged as a critical strategy to decarbonize the transportation sector. However, limited battery capacity, power, energy, and lifetime and high cost pose significant challenges to realizing equitable electric mobility solutions. Optimizing battery systems for energy and power density targets with a single chemistry solution is complex and costly, requiring new battery development for each target set.

### SUMMARY

An energy transfer unit includes a power-dense DC-DC converter for each power-dense battery module of a power-dense battery pack. Each power-dense DC-DC converter is connected to a power-dense battery module of the power-dense battery pack and to an auxiliary bus providing power to an auxiliary load. The energy transfer unit includes an energy-dense DC-DC converter for each energy-dense battery module of an energy-dense battery pack. Each energy-dense DC-DC converter is connected to an energy-dense battery module of the energy-dense battery pack and to the auxiliary bus. The energy transfer unit includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack.

A composite hybrid energy-storage system includes a plurality of power-dense battery modules in a power-dense battery pack, a plurality of energy-dense battery modules in an energy-dense battery pack, and an auxiliary bus providing power to an auxiliary load. The composite hybrid energy-storage system includes a power-dense DC-DC converter for each power-dense battery module of the power-dense battery pack. Each power-dense DC-DC converter is connected to a power-dense battery module of the power-dense battery pack and to the auxiliary bus. The composite hybrid energy-storage system includes an energy-dense DC-DC converter for each energy-dense battery module of the energy-dense battery pack. Each energy-dense DC-DC converter is connected to the energy-dense battery module of the energy-dense battery pack and to the auxiliary bus. The composite hybrid energy-storage system includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack.

Another energy transfer unit includes a power-dense DC-DC converter for each power-dense battery module of a power-dense battery pack. Each power-dense DC-DC converter is connected to a power-dense battery module of the power-dense battery pack and to an auxiliary bus providing power to an auxiliary load. The energy transfer unit includes an energy-dense DC-DC converter for each energy-dense battery module of an energy-dense battery pack. Each energy-dense DC-DC converter is connected to an energy-dense battery module of the energy-dense battery pack and to the auxiliary bus. The energy transfer unit includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack. The energy transfer unit includes an assistive mode circuit configured to, during an assistive mode, provide power to the auxiliary load in response to the auxiliary load comprising an atypical load that exceeds a power limit of the energy-dense battery pack. The assistive mode circuit overrides the energy balance circuit to allow the average SOC of the power-dense battery pack to decrease below the SOC setpoint. The energy transfer unit includes a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit. The rapid recovery circuit overrides the assistive mode circuit during the recovery mode.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is schematic block diagram illustrating a composite hybrid energy-storage system (“CHESS”) with an energy transfer unit (“ETU”), according to various embodiments;

FIG. 2 is schematic block diagram illustrating elements of the CHESS of FIG. 1 with an energy-dense battery pack, a power-dense battery pack, and a more detailed energy transfer unit, according to various embodiments;

FIG. 3 is a schematic block diagram illustrating a more detailed CHESS with an energy transfer unit, according to various embodiments;

FIG. 4 is a schematic block diagram illustrating a possible direct current (“DC”)-DC converter for a battery energy module of the system of FIG. 3, according to various embodiments;

FIG. 5 is a diagram illustrating a discharge cycle for the CHESS with an ETU illustrating state-of-charge (“SOC”) of the energy-dense battery pack and the SOC of the power-dense battery pack, according to various embodiments;

FIG. 6 is a schematic block diagram illustrating energy-dense battery pack controls and power-dense battery pack controls without assistive mode, according to various embodiments;

FIG. 7 is a schematic block diagram illustrating energy-dense battery pack controls and power-dense battery pack controls with assistive mode, according to various embodiments;

FIG. 8 is a schematic block diagram illustrating simplified control operation for non-assistive mode and for assistive mode, according to various embodiments;

FIG. 9 depicts the low voltage DC bus voltage and SOC for the power-dense battery pack without assistive mode, with assistive mode, and with assistive mode and recovery mode, according to various embodiments;

FIG. 10 is a schematic block diagram illustrating energy-dense battery pack controls and power-dense battery pack controls with assistive mode and recovery mode, according to various embodiments;

FIG. 11 is a schematic block diagram illustrating charge recovery during recovery mode, according to various embodiments;

FIG. 12 is a diagram illustrating charge recovery for two overlapping atypical loads, according to various embodiments;

FIG. 13 is a schematic block diagram illustrating simplified control operation for non-assistive mode, for assistive mode, and recovery mode according to various embodiments;

FIG. 14 is a table of converter parameters for an experimental test setup, according to various embodiments;

FIG. 15 is a diagram illustrating a system for an experimental test setup, according to various embodiments;

FIG. 16 depicts a closed-loop response of the hardware setup when the converters of the ETU transition from the non-assistive to assistive mode during discharging of the power-dense cells, according to various embodiments;

FIG. 17 depicts a closed-loop response of the hardware setup when the converters of the ETU transition from the assistive to recovery mode during discharging of the power-dense cells, according to various embodiments;

FIG. 18 depicts a closed-loop response of the hardware setup when the converters of the ETU transition from the recovery to non-assistive mode during discharging of the power-dense cells, according to various embodiments;

FIG. 19 depicts a closed-loop response of the hardware setup when the converters of the ETU transition from the non-assistive to assistive mode during charging of the power-dense cells, according to various embodiments;

FIG. 20 depicts a closed-loop response of the hardware setup when the converters of the ETU transition from charging to discharging to charging during the assistive mode, according to various embodiments;

FIG. 21 depicts a closed-loop response of the hardware setup when the converters of the ETU transition from the assistive to recovery mode during charging of the power-dense cells, according to various embodiments; and

FIG. 22 depicts a closed-loop response of the hardware setup when the converters of the ETU transition from the recovery to non-assistive mode during charging of the power-dense cells, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Many of the functional units described in this specification have been labeled as modules or circuits, in order to more particularly emphasize their implementation independence. For example, all or a portion of a module or a circuit may be implemented as hardware circuits, a hardware circuit comprising custom very large scale integrated (“VLSI”) circuits or gate arrays, off-the-shelf semiconductors such as logic chips, transistors, or other discrete components. All or a portion of a module or a circuit may also be implemented in programmable hardware devices such as a field programmable gate array (“FPGA”), programmable array logic, programmable logic devices or the like.

All or a portion of modules and circuits may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An energy transfer unit includes a power-dense DC-DC converter for each power-dense battery module of a power-dense battery pack. Each power-dense DC-DC converter is connected to a power-dense battery module of the power-dense battery pack and to an auxiliary bus providing power to an auxiliary load. The energy transfer unit includes an energy-dense DC-DC converter for each energy-dense battery module of an energy-dense battery pack. Each energy-dense DC-DC converter is connected to an energy-dense battery module of the energy-dense battery pack and to the auxiliary bus. The energy transfer unit includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack.

In some embodiments, the energy balance circuit includes a voltage compensation loop configured to regulate the voltage of the auxiliary bus to an auxiliary bus setpoint, where the voltage compensation loop provides an energy-dense current reference to each of the energy-dense DC-DC converters, and an average SOC compensation loop configured to regulate the average SOC of the power-dense battery pack to the SOC setpoint. The average SOC compensation loop provides a power-dense current reference to each of the power-dense DC-DC converters.

In some embodiments, the energy transfer unit includes an assistive mode circuit configured to, during an assistive mode, provide power to the auxiliary load in response to the auxiliary load including an atypical load that exceeds a power limit of the energy-dense battery pack. The assistive mode circuit overrides the energy balance circuit to allow the average SOC of the power-dense battery pack to decrease below the SOC setpoint. In other embodiments, the energy balance circuit includes an energy-dense upper current limit for the energy-dense battery pack and the assistive mode circuit includes a current feedforward loop configured to, during the assistive mode, override the average SOC compensation loop maintaining the average SOC of the power-dense battery pack in response to current from the energy-dense battery pack exceeding the energy-dense upper current limit. The assistive mode circuit is configured to lower the average SOC of the power-dense battery pack by modifying a power-dense current reference to each power-dense DC-DC converter.

In other embodiments, the energy transfer unit includes a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit. The rapid recovery circuit overrides the assistive mode circuit during the recovery mode. In other embodiments, the rapid recovery circuit includes a recovery feedforward loop configured to, during the recovery mode, override the assistive mode circuit and to increase the average SOC of the power-dense battery pack to a SOC in compliance with the SOC setpoint by modifying a power-dense current reference to each of the power-dense DC-DC converters. In other embodiments, the energy transfer unit includes a shutdown circuit configured to monitor an overall SOC of the power-dense battery modules and the energy-dense battery modules and to send a shutdown signal to each of the power-dense DC-DC converters and the energy-dense DC-DC converters in response to the overall SOC reaching an overall SOC minimum threshold. The shutdown signal causes the power-dense DC-DC converters and the energy-dense DC-DC converters to stop providing power to the auxiliary load.

In some embodiments, each of the energy-dense DC-DC converters isolates each of the energy-dense battery modules from the auxiliary bus and each of the power-dense DC-DC converters isolates each of the power-dense battery modules from the auxiliary bus. In other embodiments, each of the energy-dense DC-DC converters and each of the power-dense DC-DC converters have a dual active bridge converter topology. In other embodiments, each of the power-dense battery modules of the power-dense battery pack is connected in series and the power-dense battery pack is connected in series with a capacitor. The power-dense battery pack and the capacitor are connected to a high-voltage bus providing power to a high-voltage load, and each of the energy-dense battery modules of the energy-dense battery pack are connected in series and terminals of the energy-dense battery pack are connected in parallel with the power-dense battery pack and capacitor on the high-voltage bus. The high-voltage bus includes a bus voltage higher than a bus voltage of auxiliary bus.

In some embodiments, each of the power-dense battery modules of the power-dense battery pack is optimized for proving current during transient load conditions and each of the energy-dense battery modules of the energy-dense battery pack is optimized to have a high amount of available energy over a wide discharge power range. In other embodiments, the power-dense battery modules of the power-dense battery pack have a higher specific power than the energy-dense battery modules of the energy-dense battery pack and the energy-dense battery modules of the energy-dense battery pack have a higher specific energy than the power-dense battery modules of the power-dense battery pack.

A composite hybrid energy-storage system includes a plurality of power-dense battery modules in a power-dense battery pack, a plurality of energy-dense battery modules in an energy-dense battery pack, and an auxiliary bus providing power to an auxiliary load. The composite hybrid energy-storage system includes a power-dense DC-DC converter for each power-dense battery module of the power-dense battery pack. Each power-dense DC-DC converter is connected to a power-dense battery module of the power-dense battery pack and to the auxiliary bus. The composite hybrid energy-storage system includes an energy-dense DC-DC converter for each energy-dense battery module of the energy-dense battery pack. Each energy-dense DC-DC converter is connected to the energy-dense battery module of the energy-dense battery pack and to the auxiliary bus. The composite hybrid energy-storage system includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack.

In some embodiments, the energy balance circuit includes a voltage compensation loop configured to regulate the voltage of the auxiliary bus to an auxiliary bus setpoint, where the voltage compensation loop provides an energy-dense current reference to each of the energy-dense DC-DC converters, and an average SOC compensation loop configured to regulate the average SOC of the power-dense battery pack to the SOC setpoint, where the average SOC compensation loop provides a power-dense current reference to each of the power-dense DC-DC converters. In other embodiments, the composite hybrid energy-storage system includes an assistive mode circuit configured to, during an assistive mode, provide power to the auxiliary load in response to the auxiliary load including an atypical load that exceeds a power limit of the energy-dense battery pack. The assistive mode circuit overrides the energy balance circuit to allow the average SOC of the power-dense battery pack to decrease below the SOC setpoint.

In other embodiments, the composite hybrid energy-storage system includes a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit. The rapid recovery circuit overrides the assistive mode circuit during the recovery mode. In other embodiments, each of the energy-dense DC-DC converters isolates each of the energy-dense battery modules from the auxiliary bus and each of the power-dense DC-DC converters isolates each of the power-dense battery modules from the auxiliary bus. In other embodiments, the composite hybrid energy-storage system includes a capacitor and a high-voltage bus providing power to a high-voltage load. Each of the power-dense battery modules of the power-dense battery pack is connected in series and the power-dense battery pack is connected in series with the capacitor, the power-dense battery pack and the capacitor are connected to the high-voltage bus, and each of the energy-dense battery modules of the energy-dense battery pack is connected in series and terminals of the energy-dense battery pack are connected in parallel with the power-dense battery pack and capacitor on the high-voltage bus, the high-voltage bus comprising a bus voltage higher than a bus voltage of auxiliary bus.

Another energy transfer unit includes a power-dense DC-DC converter for each power-dense battery module of a power-dense battery pack. Each power-dense DC-DC converter is connected to a power-dense battery module of the power-dense battery pack and to an auxiliary bus providing power to an auxiliary load. The energy transfer unit includes an energy-dense DC-DC converter for each energy-dense battery module of an energy-dense battery pack. Each energy-dense DC-DC converter is connected to an energy-dense battery module of the energy-dense battery pack and to the auxiliary bus. The energy transfer unit includes an energy balance circuit configured to maintain an average state-of-charge (“SOC”) of the power-dense battery pack at a SOC setpoint, regulate voltage of the auxiliary bus, and control each energy-dense battery module of the energy-dense battery pack. The energy balance circuit draws power from the energy-dense battery pack to maintain the average SOC of the power-dense battery pack. The energy transfer unit includes an assistive mode circuit configured to, during an assistive mode, provide power to the auxiliary load in response to the auxiliary load comprising an atypical load that exceeds a power limit of the energy-dense battery pack. The assistive mode circuit overrides the energy balance circuit to allow the average SOC of the power-dense battery pack to decrease below the SOC setpoint. The energy transfer unit includes a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit. The rapid recovery circuit overrides the assistive mode circuit during the recovery mode.

In some embodiments, each of the power-dense battery modules of the power-dense battery pack are connected in series and the power-dense battery pack is connected in series with a capacitor. The power-dense battery pack and the capacitor are connected to a high-voltage bus providing power to a high-voltage load. Each of the energy-dense battery modules of the energy-dense battery pack is connected in series and terminals of the energy-dense battery pack are connected in parallel with the power-dense battery pack and capacitor on the high-voltage bus. The high-voltage bus includes a bus voltage higher than a bus voltage of auxiliary bus.

### I. INTRODUCTION

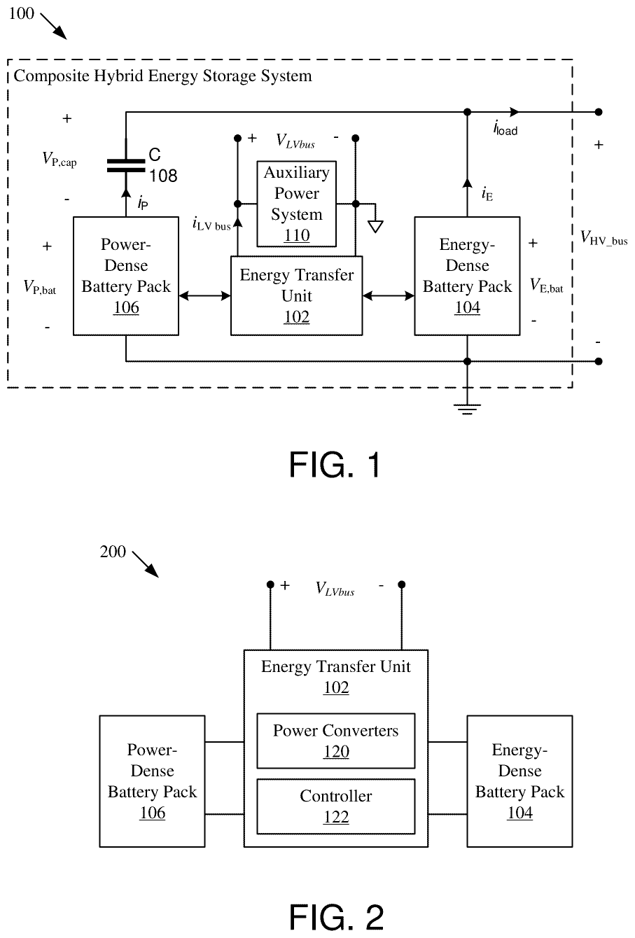

FIG. 1 is schematic block diagram illustrating a composite hybrid energy-storage system (“CHESS”) 100 with an energy transfer unit (“ETU”) 102, according to various embodiments. The CHESS architecture utilizes a combination of an energy-dense battery pack 104 and a power-dense battery pack 106 and a capacitor 108, which may be a supercapacitor. The approach achieves a smaller, more cost-effective, and lightweight energy storage system for electric vehicles (“EVs”) while overcoming the common challenges of circulating current, over-discharging, overcharging, and limited utilization of energy storage elements in parallel-connected heterogenous battery systems. As depicted in FIG. 1, the propulsion system of the EV and an auxiliary power system of the EV are powered by the CHESS architecture 100.

The CHESS architecture 100 includes an ETU 102 that isolates the high-voltage (“HV”) energy storage elements from the auxiliary loads and regulates the auxiliary low-voltage (“LV”) direct current (“DC”) bus voltage VLVbus. The LV DC bus of the ETU 102 typically serves two key functions: firstly, the ETU 102 facilitates energy balancing between the power-dense and energy-dense battery packs 104, 106 to improve their performance and life. Secondly, the ETU 102 provides a means to support auxiliary loads on an auxiliary power system 110 on the EV, thereby increasing the EV's overall utility. The CHESS 100 also includes a capacitor C 108 in series with the power-dense battery pack 106, which is discussed further below.

FIG. 2 is schematic block diagram 200 illustrating elements of the CHESS 100 of FIG. 1 with an energy-dense battery pack 104, a power-dense battery pack 106, and a more detailed energy transfer unit 102, according to various embodiments. The energy transfer unit 102 includes power converters 120, which are typically in the form of DC-DC converters. The energy transfer unit 102 also includes a controller 122, which controls the power converters 120 to service a high-voltage load, provide energy balance between the energy-dense battery pack 104 and the power-dense battery pack 106, and also to regulate the low voltage bus to provide power to the auxiliary power system 110.

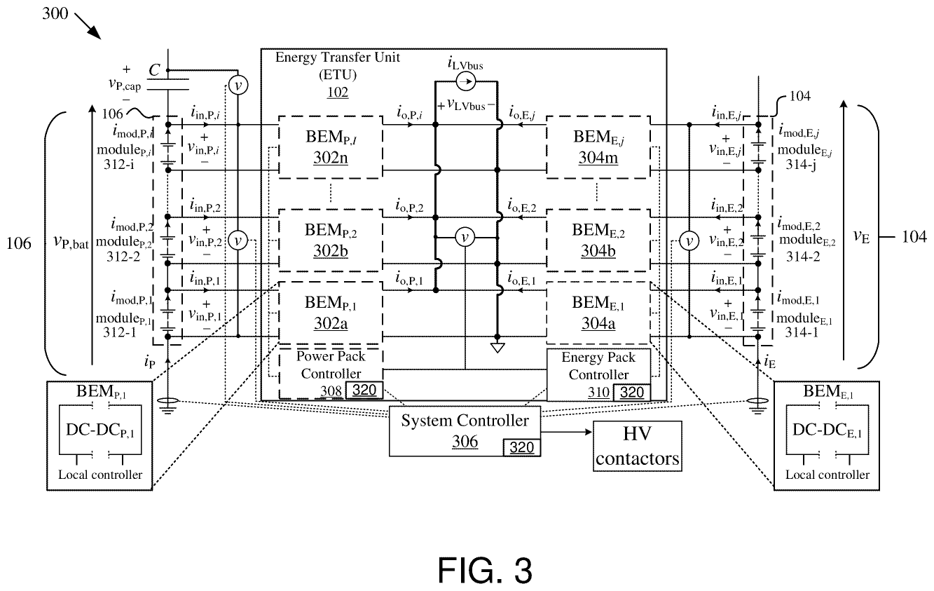

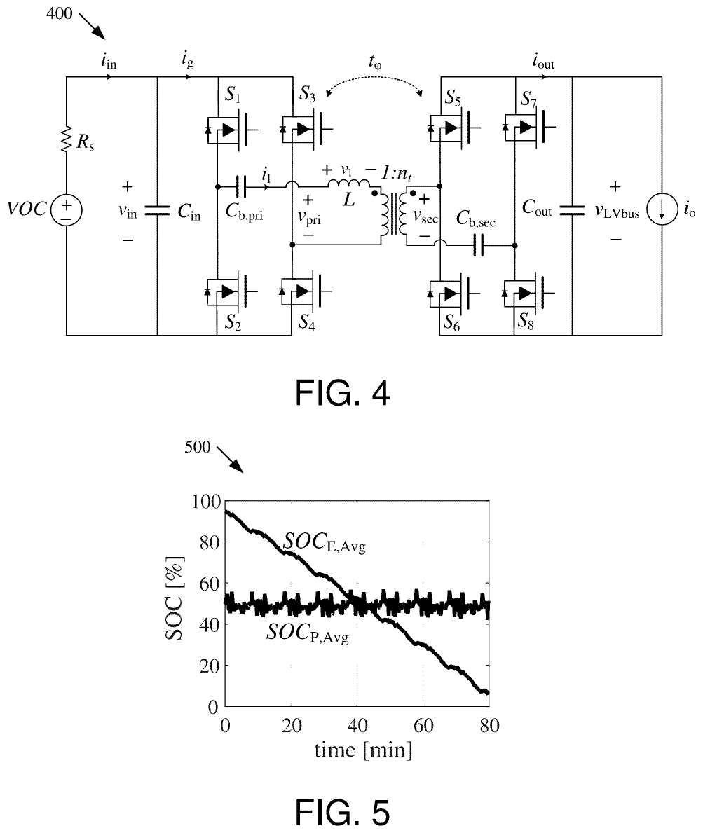

FIG. 3 is a schematic block diagram illustrating a system 300 with a more detailed CHESS with an energy transfer unit 102, according to various embodiments. As shown in FIG. 3, the ETU 102 comprises battery energy modules (“BEMs”). In some embodiments, the BEMs include low-power isolated DC-DC converters 302a-n, 304a-m. FIG. 4 is a schematic block diagram illustrating a possible direct current DC-DC converter 400 for a battery energy module of the system 300 of FIG. 3, according to various embodiments. The DC-DC converter is a dual active bridge converter, which is bi-directional and provides isolation between the input and the output of the DC-DC converter 400. In other embodiments, other DC-DC converter topologies are used that include isolation between the input and the output.

The ETU 102 includes a power-dense DC-DC converter BEM 302 for each power-dense battery module (e.g., module_{P1}-module_{Pi}) 312-1 to 312-i (generically or collectively “312”) of a power-dense battery pack 106. Each power-dense DC-DC converter BEM 302 is connected to a power-dense battery module 312 of the power-dense battery pack 106 and to an auxiliary bus (e.g., LV DC bus) providing power to an auxiliary load of the auxiliary power system 110. The power-dense DC-DC converters 302a-302n, which are depicted as BEM_{P,1} 302a to BEM_{P,I} 302n, are connected to the power-dense battery modules 312-1 to 312-i. The term “power-dense DC-DC converter,” as used herein, refers to the DC-DC converters connected to the power-dense battery modules 312 and not to any characteristic of the DC-DC converters. The power-dense DC-DC converters 302 include any suitable DC-DC converter capable of a voltage range on one side suitable for the power-dense battery modules 312 and a voltage range connected to the auxiliary bus that is suitable for the auxiliary bus where the power-dense DC-DC converters 302 provide isolation between the auxiliary bus and the power-dense battery modules 312.

The ETU 102 includes an energy-dense DC-DC converter BEM 304 for each energy-dense battery module (module_{E1}-module_{Ej}) 314-1 to 314-j (generically or collectively “314”) of an energy-dense battery pack 104. Each energy-dense DC-DC converter BEM 304 is connected to an energy-dense battery module 314 of the energy-dense battery pack 104 and to the auxiliary bus. The energy-dense DC-DC converters 304a-304m, which are depicted as BEM_{E,1} 304a to BEM_{E,J} 304m, are connected to the energy-dense battery modules 314-1 to 314-j. The term “energy-dense DC-DC converter,” as used herein, refers to the DC-DC converters connected to the energy-dense battery modules 314 and not to any characteristic of the DC-DC converters. The energy-dense DC-DC converters 304 include any suitable DC-DC converter capable of a voltage range on one side suitable for the energy-dense battery modules 314 and a voltage range connected to the auxiliary bus that is suitable for the auxiliary bus where the energy-dense DC-DC converters 304 provide isolation between the auxiliar bus and the energy-dense battery modules 314. The ETU 102 includes an energy balance circuit 320, which, in some embodiments, is included in the controllers (306, 308, and/or 310). The energy balance circuit 320 is configured to maintain an average state-of-charge (“SOC”) of the power-dense battery pack 106 at a SOC setpoint during normal operation. In some examples, the SOC setpoint is 50% of the SOC of the power-dense battery pack 106.

The energy balance circuit 320 is configured to regulate voltage of the auxiliary bus (e.g., LV DC bus). In some examples, the energy balance circuit 320 maintains the LV DC bus voltage to 12 volts (“V”), 24 V, 48 V, or the like. The energy balance circuit 320 is configured to control each energy-dense battery module 314 of the energy-dense battery pack 106 where the energy balance circuit 320 draws power from the energy-dense battery pack 104 to maintain the average SOC of the power-dense battery pack 106.

At the input, the DC-DC converters of the BEMs 302, 304 are connected to series-connected modules of cells in the energy-dense battery pack 104 and the power-dense battery pack 106. At the output, the DC-DC converters of the BEMs 302, 304 are connected in parallel to the auxiliary LV DC bus, supplying power to auxiliary loads of the auxiliary power system 110 in the EV. The controllers (system controller 306, power pack controller 308, and energy controller 310) of the ETU 102 achieves energy balancing by utilizing the BEMs 302 of the power-dense battery pack 106 to maintain the average SOC SOC_{P,avg} of the power-dense battery pack 106 around a desired average SOC setpoint SOC_{P,avg,ref}, which in some embodiments may be of 50 percent (%), as depicted in FIG. 5. In some embodiments, the system controller 306 includes other functions, such as control of the high voltage bus, operation of contacts to add and remove load, and the like. Note that the system controller 306, power pack controller 308, and energy controller 310 are depicted for convenience and functions of the controllers 306, 308, 310 may be distributed within or without the ETU 102 as desired or required.

In some embodiments, the power-dense battery modules 312 and the power-dense battery modules 314 each include a single battery. In other embodiments, the power-dense battery modules 312 and the power-dense battery modules 314 each include two or more batteries, which may be combined in series, in parallel, or a combination with some in series and some in parallel. In some embodiments, the power-dense battery modules 312 and the power-dense battery modules 314 each include batteries of a particular configuration to meet a voltage requirement and/or a capacity requirement.

FIG. 5 is a diagram 500 illustrating a discharge cycle for the CHESS (e.g., 100, 200, 300) with an ETU 102 illustrating average SOC of the energy-dense battery pack and the average SOC of the power-dense battery pack, according to various embodiments. As is demonstrated in FIG. 5, as the average SOC of the energy-dense battery pack SOC_{E,Avg} decreases from a maximum of about 95% to a minimum of about 10%, the average SOC of the power-dense battery pack SOC_{P,Avg} remains relatively constant at about 50%, while providing current to transient-type loads. In some embodiments, the chosen value of SOC_{P,avg,ref} is considered an efficient setpoint for traction batteries. The control strategy simultaneously regulates the LV DC bus voltage v_{LV_bus} through the BEMs 304 of the energy-dense battery pack 104. Embodiments described herein include a new aspect to the controllers 306, 308, 310 to enable the vehicle to accommodate intermittent auxiliary loads effectively.

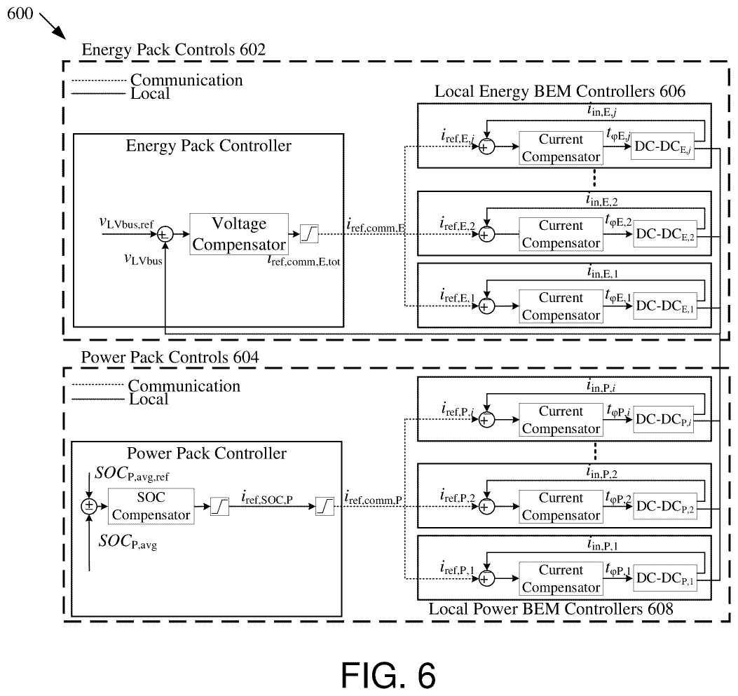

FIG. 6 is a schematic block diagram 600 illustrating energy-dense battery pack controls 602 and power-dense battery pack controls 604 without assistive mode, according to various embodiments. In some embodiments, the energy balance circuit 320 includes a voltage compensation loop configured to regulate the voltage v_{LVbus} of the auxiliary bus to an auxiliary bus setpoint v_{LVbus,ref}. Each energy-dense DC-DC converter BEM_{E,j} 304 also includes a current control loop within the local energy BEM controllers 606 to regulate current from an energy-dense battery moule 314 to a current setpoint. The voltage compensation loop provides an energy-dense current reference i_{ref,comm,E} to each of the energy-dense DC-DC converters BEM_{E,j} 304. In FIG. 6, the voltage compensation loop includes the voltage feedback signal v_{LVbus}, the comparator summing v_{LVbus} and v_{LVbus,ref}, the voltage compensator, and limiter at the output of the voltage compensator in the energy-dense battery pack controls 602. Other embodiments include other elements and other voltage compensation schemes that regulate voltage of the auxiliary bus.

The energy-dense battery pack controls 602 and the power-dense battery pack controls 604 are depicted as separate with no feedforward control for an assistive mode. In the depicted embodiments, the energy-dense battery pack controls 602 includes a feedback loop that uses a LV DC bus setpoint v_{VLbus,ref} to control a current reference to each energy-dense BEM 304 to maintain the LV DC bus voltage.

In some embodiments, the energy balance circuit includes an average SOC compensation loop in the power-dense battery pack controls 604 configured to regulate the average SOC of the power-dense battery pack 106 to the SOC setpoint. The average SOC compensation loop provides a power-dense current reference i_{ref,comm,P} to each of the power-dense DC-DC converters in the power-dense BEMs 302. Each power-dense DC-DC converter BEM_{P,j} 302 also includes a current control loop within the local power BEM controllers 608 to regulate current from an power-dense battery moule 312 to a current setpoint. The average SOC compensation loop includes an average SOC of the power-dense battery modules 312 of the power-dense battery pack 106, a SOC setpoint SOC_{P,avg,ref}, the SOC compensator, and the following limiters power-dense battery pack controls 604.

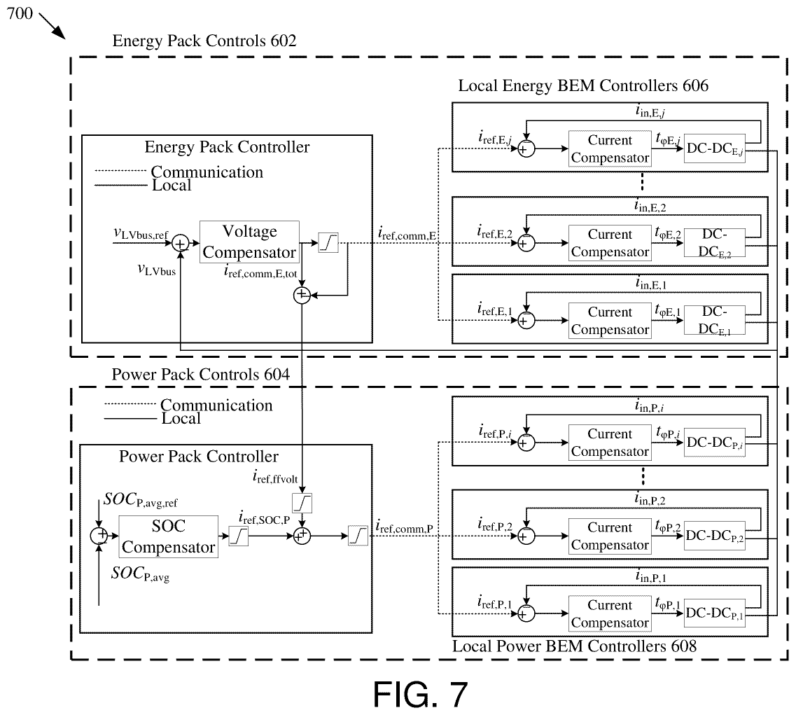

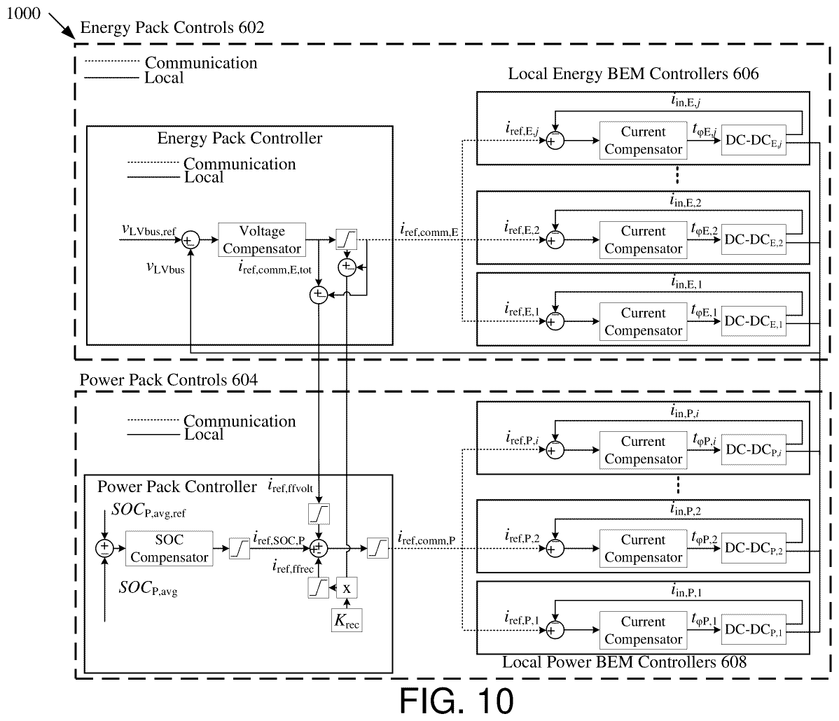

The power-dense battery pack controls 604 calculates an average SOC of the power-dense battery modules 312 of the power-dense battery pack 106 to compare to a power-dense SOC setpoint SOC_{P,avg,ref} so the power-dense battery pack controls 604 maintain the SOC of each power-dense battery module 312 at the power-dense SOC setpoint SOC_{P,avg,ref}. In some embodiments, the ETU 102 does not include an assistive mode or a recovery mode, as depicted in FIG. 6. In other embodiments, FIG. 6 depicts when the assistive mode and the recovery mode are inactive by not including feedforward loops, as shown in FIGS. 7 and 10.

The ETU 102 has the potential to act as a substitute for or supplement to a HV-to-LV step-down DC-DC converter that is typically employed in EVs. The vehicle's LV DC bus facilitates the operation of auxiliary loads of the auxiliary power system 110 such as lighting, electric fans/pumps/compressors, and instrumentation electronics. The energy balance circuit 320 commonly maintains LV DC bus at voltage levels of 12 V, 24 V, or 48 V, encompassing power typically ranging from 2 kW to 5 kW. The voltage selection is based on the functionalities and capabilities of the vehicle system.

Currently, EVs are assuming the role of power providers for various connected loads. The Ford® F-150 Lightning exemplifies this trend by offering the capacity to supply power to a home during instances of power outages. Similarly, the Rivian® R1 Truck features a camp kitchen equipped with a 1.44 kW induction stovetop. EVs are often outfitted with the capability known as vehicle-to-load (“V2L”), which enables the provision of alternating current (“AC”) power to various appliances or loads, including but not limited to lights, laptops, televisions, refrigerators, etc. These additional functionalities not only augment the user experience but also differ from conventional auxiliary loads that are typically considered in the design of the auxiliary system's capacity.

When additional loads are connected to the LV DC bus of an EV, leading to augmented power demand for the auxiliary power system, this may occur outside the realm of regular operation. Consequently, the power required from the BEMs 304 of the energy-dense battery pack 104 can exceed their rated power, causing the auxiliary LV DC bus voltage to drop below a LV DC bus setpoint. As a result, the EV auxiliary loads may not function as desired. The proposed multi-mode control strategy with feedforward control overcomes the limitations of traditional regulation methods in the presence of heavy auxiliary loads. The control strategies described herein allow the LV DC bus voltage V_{LVbus} bus regulation feedback to temporarily override the power-dense battery pack SOC SOC_{P,avg} regulation and to prioritize power delivery to the auxiliary load.

The proposed multimode control strategy facilitates the provision of enhanced power to connected loads by surpassing the designed capability of the LV DC bus. Under regular operational circumstances, the power-dense battery pack 106 is not employed for the purpose of consistently powering auxiliary loads, as such usage would deplete the energy reserves of the power-dense battery pack 106. The proposed control, in some embodiments, enhances the auxiliary LV DC bus voltage regulation in hybrid lithium-ion (“Li-ion”) battery systems. Key contributions of the proposed control strategy are: 1) effective energy storage balance while concurrently regulating the shared auxiliary LV DC bus voltage, and 2) substantial enhancement of the power delivered by the ETU 102, particularly when subjected to heavy and dynamic auxiliary loads. Hardware results are presented for a 1.1 kW system consisting of two BEMs, each connected to six series-connected 50 ampere-hour (“Ah”) lithium nickel manganese cobalt oxide (“NMC”) cells. The results show that the LV bus voltage v_{LVbus} is regulated at 12 V under dynamic loads.

### II. MULTI-MODE CONTROL STRATEGY WITH FEEDFORWARD CONTROL

The ETU 102, consisting of DC-DC converters, is a vital link between the two battery packs 104, 106, achieving the regulation of the average SOC of the power-dense battery pack SOC_{P,avg}, and the LV DC bus. FIG. 7 is a schematic block diagram 700 illustrating energy-dense battery pack controls and power-dense battery pack controls with assistive mode, according to various embodiments. In some embodiments, the ETU 102 includes an assistive mode circuit configured to, during an assistive mode, provide power to the auxiliary load in response to the auxiliary load having an atypical load that exceeds a power limit of the energy-dense battery pack 104. The assistive mode circuit overrides the energy balance circuit 320 to allow the average SOC of the power-dense battery pack 106 to decrease below the SOC setpoint. In FIG. 7, the assistive mode circuit is embodied by the feedforward control extending between the energy-dense battery pack controls 602 and the power-dense battery pack controls 604, as described below.

The multi-mode control strategy, as shown in FIG. 7, incorporates the feedforward control that regulates the LV DC bus voltage at 12 V and maintains the average power-dense battery SOC SOC_{P,avg} around 50% under dynamic loads. Each BEM 302 has a localized input current controller that regulates the DC-DC converter input current to the current reference from the corresponding pack controller. The input current feedback loop gain, in the depicted embodiments, is compensated by utilizing a conventional proportional and integral (“PI”) compensator, denoted as G_{ci}. The resulting compensated input current feedback loop gain is:

$${T}_{i} = {G}_{i ∅} {G}_{ci} {H}_{i} \cdot {H}_{∅} \qquad ( 1 )$$

where G_{iΦ} is the input control-to-input transfer function, Hᵢ is the current sensor gain, and H_{ϕ} is the pulse width modulation (“PWM”) modulator gain.

The reference current for BEMs in the energy-dense battery pack, i_{ref,comm,E}, is determined by the LV DC bus voltage regulation loop. The compensated voltage feedback loop gain is:

$${T}_{v} = \frac{{G}_{vi} {G}_{cv} {H}_{v} {G}_{i}}{{H}_{i}} , \qquad ( 2 )$$

where Gᵥᵢ is the input current-to-output voltage transfer function, G_{cv} is a standard PI compensator, Hᵥ is the voltage sensor gain, and Gᵢ is the closed-loop response of the input current loop.

Meanwhile, the reference current for BEMs 302 in the power-dense battery pack 106, i_{ref,comm,P}, is determined by the average SOC regulation loop and the enhanced voltage regulating feedforward control. The compensated average SOC loop gain is:

$${T}_{SOC , avg} = \frac{{G}_{SOCP} {G}_{cSOCavg} {G}_{i}}{{H}_{i}} , \qquad ( 3 )$$

where G_{SOCP} is the battery cell transfer function, and G_{csOCavg} is a standard proportional controller designed for compensation.

In some embodiments, the energy balance circuit 320 includes an energy-dense upper current limit (e.g., the saturation limits, i_{in,E,limit} on the common current reference, i_{ref,comm,E} described below) for the energy-dense battery pack 104 and the assistive mode circuit includes a current feedforward loop (see controls extending between the energy-dense battery pack controls 602 and the power-dense battery pack controls 604) configured to, during the assistive mode, override an average SOC compensation loop maintaining the average SOC of the power-dense battery pack 106 in response to current from the energy-dense battery pack exceeding the energy-dense upper current limit. The assistive mode circuit is configured to lower the average SOC of the power-dense battery pack 106 by modifying a power-dense current reference i_{ref,comm,P} to each power-dense DC-DC converter in each of the power-dense BEMs 302.

Regulation of the LV DC bus voltage is achieved by the common current reference generated by the voltage regulation loop of the energy-dense battery pack controller 602. The input current of the energy-dense battery pack's DC-DC converter 304, i_{in,E} is prevented from exceeding its rated value through saturation limits, i_{in,E,limit} on the common current reference, i_{ref,comm,E}. If the required power exceeds the rated power of the DC-DC converters due to augmented auxiliary loads, the input current reference, i_{ref,comm,E}, saturates to i_{in,E,limit}. Consequently, the energy pack and power pack controllers coordinate to modify the common current reference for the BEMs 302 of the power-dense battery pack 106, i_{ref,comm,P}, to assist with voltage regulation.

As shown in FIG. 7, a feedforward current reference term, i_{ref,ffvolt}, is generated using the voltage regulation feedback loop as:

$${i}_{ref , ffvolt} = {i}_{ref , comm , E , tot} - {i}_{ref , comm , E} , \qquad ( 4 )$$

where i_{ref,comm,E,tot} is the common current reference generated by the LV DC bus regulation feedback loop that has no saturation limits, and i_{ref,comm,E} is the common current reference generated by the LV DC bus regulation feedback loop that has saturation limits i_{in,E,limit}.

The value of i_{ref,ffvolt} is combined with the reference current generated by the power-dense battery pack's average SOC regulation loop, i_{ref,soc,P} to generate i_{ref,comm,P}, which has limits i_{in,P,limit}:

$${i}_{ref , comm , P} = {i}_{ref , ffvolt} ∓ {i}_{ref , SOC , P} , \qquad ( 5 )$$

where i_{ref,ffvolt} has limits i_{in,P,limit}+in,E,limit to allow for a change in the state of the power-dense BEMs 302 from charging to discharging, and i_{ref,SOC,P} has limits i_{in,P,limit}.

The power provision capability of the ETU 102 is equal to the total power rating of all BEMs 302, 304 in the system 100, 200, 300. The analysis of the feedback control loops for regulation of the LV DC bus voltage and the average SOC of the power-dense battery pack 106 SOC_{P,avg} remains unaffected as the feedforward dynamics are fast and do not interfere with the feedback control loops.

### III. MULTI-MODE OPERATION OF THE ETU

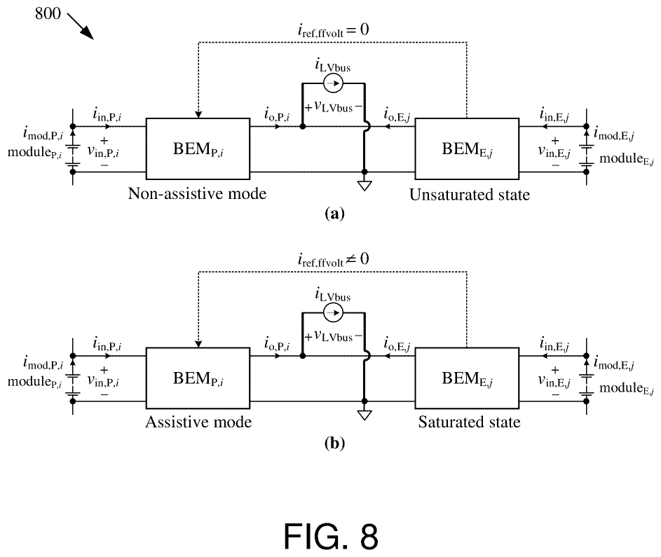

The multi-mode control strategy of Section II enables the ETU 102 to operate in three modes: 1) non-assistive, 2) assistive, and 3) recovery. FIG. 8 is a schematic block diagram 800 illustrating simplified control operation for non-assistive mode and for assistive mode, according to various embodiments. FIG. 8 displays the two modes for the BEMs 304, 302 of the energy-dense and power-dense battery packs 104, 106 (BEM_{E,j} 304 and BEM_{P,i} 302) using a simplified hybrid battery system. The operation extends to a full-size CHESS architecture and similar hybrid battery systems. The objective of each operational mode is to ensure regulation of the LV DC bus voltage under dynamic loads and balance energy between the two BEMs 302, 304.

### A. Non-Assistive Mode

In FIG. 8(a), when the combined power required by the auxiliary load and BEM_{P,i} 302 is below the rated power of BEM_{E,j} 304, BEM_{E,j} operates in an unsaturated state and BEM_{P,i} operates in a non-assistive mode, meaning that i_{ref,comm,E} is unsaturated and:

$${i}_{ref , ffvolt} = 0. \qquad ( 6 )$$

In this scenario, the average SOC regulation loop dominates, contributing to i_{ref,comm,P} and regulating SOC_{P,avg} such that:

$${i}_{ref , comm , P} = {i}_{ref , SOC , P} . \qquad ( 7 )$$

### B. Assistive Mode

When the combined power required by the auxiliary load and BEM_{P,i} 302 is higher than the rated power of the DC-DC converter in BEM_{E,j} 304 (as shown in FIG. 8(b)), BEM_{E,j} 304 becomes saturated and BEM_{P,i} 302 switches to an assistive mode, meaning that i_{ref,comm,E} is saturated and:

$${i}_{ref , ffvolt} \neq 0. \qquad ( 8 )$$

In this case, in some embodiments the feedforward control contributes to i_{ref,comm,P} using equation (5) and regulates the LV DC bus voltage. Due to the comparatively slower response characteristics of the average SOC regulation feedback loop in contrast to the feedforward control mechanism, a temporary override of SOC_{P,avg} regulation occurs. In other embodiments, the feedforward control mechanism is active based on another option, such as i_{ref,ffvolt} triggering override of the SOC_{P,avg} regulation loop using a switch or other similar mechanism.

The current i_{ref,ffvolt} is derived from i_{ref,comm,E,tot} using equation (4), generated by the voltage regulation loop compensator, so that steady-state and transient voltage regulation remains unchanged. The assistive mode using the power-dense battery pack 106 and the BEM_{P,i}s 302 allows the BEM_{P,i}s 302 to prioritize power delivery to the auxiliary load and regulate the LV DC bus voltage, which helps to increase the ability of the ETU 102 to deliver power to dynamic loads on the shared auxiliary DC bus.

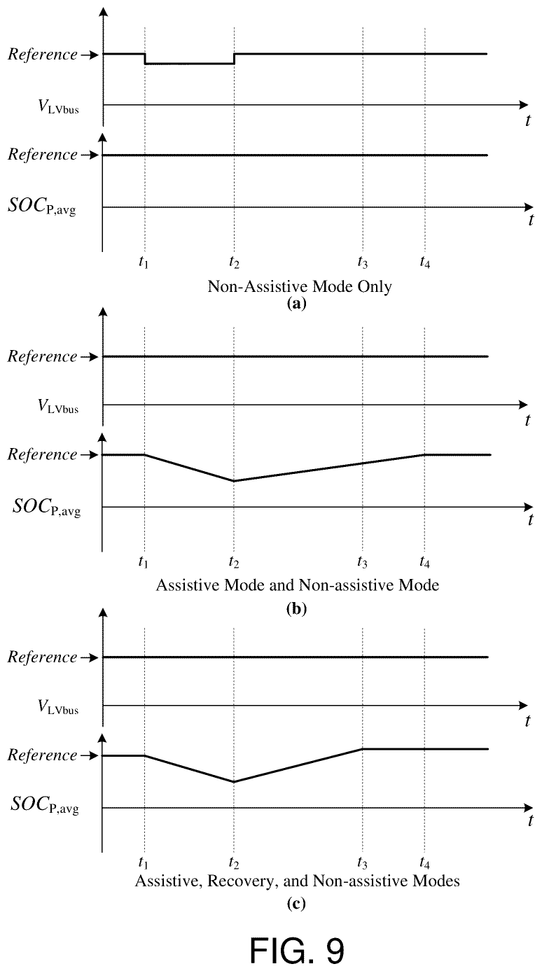

FIG. 9 depicts LV DC bus voltage and average SOC for the power-dense battery pack 106 without assistive mode, with assistive mode, and with assistive mode and recovery mode, according to various embodiments. FIG. 9 illustrates the variations in the LV DC bus voltage and the average SOC in the power-dense battery pack 106 SOC_{P,avg} in the absence (FIG. 9(a)) and presence (FIG. 9(b)) of the assistive mode. At time t1, the combined load on the energy-dense battery pack 104 and DC-DC converters 304 BEM_{E,j} increases beyond the rated power of the energy-dense battery pack 104.

Without the assistive mode, the LV DC bus voltage decreases and is no longer regulated at the desired setpoint. At time t2, the combined load on the energy-dense battery pack 104 and DC-DC converters BEM_{E,j} 304 decreases below rated power of the energy-dense battery pack 104, and the LV DC bus returns to being regulated at the desired setpoint. The average SOC of the power-dense battery pack 106 SOC_{P,avg} is well regulated at the SOC setpoint, as the power-dense battery pack 106 does not deliver energy to the auxiliary loads.

FIG. 9(b) depicts LV DC bus voltage and average SOC for the power-dense battery pack 106 with the assistive mode. With the assistive mode, the combined load on the energy-dense battery pack 104 and associated DC-DC converters BEM_{E,j} 304 increases beyond the rated power of the energy-dense battery pack 104 at time t1, and the LV DC bus voltage remains well-regulated around the desired setpoint. The average SOC of the power-dense battery pack 106 SOC_{P,avg} decreases until reaching time t2 as the power-dense battery pack 106 delivers energy to the auxiliary loads. At time t2, the combined load on the energy-dense battery pack 104 and DC-DC converters BEM_{E,j} 304 decreases below the rated power of the energy-dense battery pack 104, and the system 100, 200, 300 returns to the non-assistive mode. The average SOC of the power-dense battery pack 106 SOC_{P,avg} gradually returns to its desired setpoint at time t3. The utilization of the power-dense battery pack 106 arises when the auxiliary power demand surpasses the designated capacity of the auxiliary power system. During regular operational circumstances, the power-dense battery pack 106 does not provide power to the auxiliary loads. This restraint of not allowing decrease in SOC of the power-dense battery pack 106 prevents energy consumption from the power-dense battery pack 106 and the subsequent decline in the average SOC of the power-dense battery pack 106 SOC_{P,avg}.

c. Assistive Mode with Recovery Mode

FIG. 9(c) depicts LV DC bus voltage and average SOC for the power-dense battery pack 106 with the assistive mode and with the recovery mode and then the non-assistive mode. Again, with the assistive mode, the combined load on the energy-dense battery pack 104 and associated DC-DC converters BEM_{E,j} 304 increases beyond the rated power of the energy-dense battery pack 104 at time t1, and the LV DC bus voltage remains well-regulated around the desired setpoint. The average SOC of the power-dense battery pack 106 SOC_{P,avg} decreases until reaching time t2 as the power-dense battery pack 106 delivers energy to the auxiliary loads. At time t2, the combined load on the energy-dense battery pack 104 and DC-DC converters BEM_{E,j} 304 again decreases below the rated power of the energy-dense battery pack 104, and the recovery mode feedforward loop takes over. The average SOC of the power-dense battery pack 106 SOC_{P,avg} returns to its desired setpoint at time t3, which is quicker than allowing just the non-assistive mode to recover. The recovery mode decreases recovery time between time t2 and time t4 so that subsequent atypical loads on the LV auxiliary bus are more likely to occur when the average SOC of the power-dense battery pack 106 has fully recovered.

FIG. 10 is a schematic block diagram illustrating a system 1000 with energy-dense battery pack controls 602 and power-dense battery pack controls 604 with assistive mode and recovery mode, according to various embodiments. The system 1000 includes the feedforward loop for assistive mode, as depicted in FIG. 7 (controls extending between the energy-dense battery pack controls 602 and the power-dense battery pack controls 604) along with a second feedforward loop for recovery mode.

In some embodiments, the ETU 102 includes a rapid recovery circuit configured to, during a recovery mode following the assistive mode when power to the auxiliary load is below the power limit of the energy-dense battery pack 104, provide power to the power-dense battery modules 312 of the power-dense battery pack 106 at a rate higher than provided by the energy balance circuit 320. The rapid recovery circuit overrides the assistive mode circuit during the recovery mode. In some embodiments, the rapid recovery circuit includes a recovery feedforward loop configured to, during the recovery mode, override the assistive mode circuit and to increase the average SOC of the power-dense battery pack 106 to a SOC in compliance with the SOC setpoint by modifying an power-dense current reference i_{ref,comm,P} to each of the power-dense DC-DC converters in the power-dense BEMs 302. The rapid recovery circuit is described below and includes the feedforward loop to the right of the assistive mode circuit feedforward loop.

In some embodiments, the ETU includes a shutdown circuit (not shown) configured to monitor an overall SOC of the power-dense battery modules 312 and the energy-dense battery modules 314 and to send a shutdown signal to each of the power-dense DC-DC converters of the power-dense BEMs 302 and the energy-dense DC-DC converters of the energy-dense BEMs 304 in response to the overall SOC reaching an overall SOC minimum threshold. The shutdown signal causes the power-dense DC-DC converters and the energy-dense DC-DC converters to stop providing power to the auxiliary load.

The system 700 of FIG. 7 presented an extension of the multi-loop control approach outlined in the non-assistive mode depicted in FIG. 6. In the assistive mode, the BEMs 302 of the power-dense battery pack 106 work in tandem with those of the energy-dense battery pack 104 to supply power to auxiliary loads. However, this results in the override of the power-dense battery pack's average SOC regulation loop, leading to a decrease in the speed of the energy-balancing process between the two battery packs. Consequently, the average SOC of the power-dense battery pack 106 SOC_{P,avg} deviates from the SOC_{P,avg}, ref trajectory, which is helpful for maintaining energy balancing, and as discussed previously, it is recommended for EV Li-ion batteries to operate around 50% SOC to minimize degradation.

Although the non-assistive mode eventually restores energy balancing, the non-assistive mode fails to account for the cumulative divergence in the SOC_{P,avg} trajectory. To address this issue, an additional mode, termed the recovery mode, is introduced immediately after the assistive mode. During the recovery mode, the DC-DC converters connected to the energy-dense battery pack 104 continue to regulate the LV DC bus voltage, while those connected to the power-dense battery pack 106 maintain the average SOC of the power-dense battery pack 106 SOC_{P,avg}. Moreover, the multi-loop control approach is enhanced by incorporating feedforward control to facilitate rapid recovery of the energy balancing trajectory.

The revised control strategy presents a novel methodology for leveraging feedforward control to recover energy expenditure incurred during the assistive mode. Specifically, the voltage regulation feedback is utilized to generate a feedforward current reference, which is subsequently fed to the BEMs 302 of the power-dense battery pack 106. This recovery mode feedforward control aids in the regulation of the average SOC of the power-dense battery pack 106 SOC_{P,avg}, thereby improving the energy balancing capabilities in hybrid Li-ion battery systems 100, 200, 300.

The updated multi-loop and multi-mode control strategy depicted in FIG. 10 incorporates feedforward control to enhance the regulation of the average SOC of the power-dense battery pack 106 SOC_{P,avg} around the SOC target value of 50%. Each BEM 302 is equipped with a localized input current controller that regulates the DC-DC converter input current to the current reference obtained from the corresponding pack controller. Specifically, the reference current for BEMs 304 located in the energy-dense battery pack 104, denoted as i_{ref,comm,E}, is determined by the LV DC bus voltage regulation loop. Following the completion of the assistive mode, the reference current for BEMs 302 in the power-dense battery pack 106, denoted as i_{ref,comm,P}, is determined by the average SOC regulation loop of the power-dense battery pack 106 in conjunction with the enhanced energy balancing feedforward control mechanism.

As in the multi-loop control approach described in conjunction with the system 600 of FIG. 6, regulation of the LV DC bus voltage is achieved by the common current reference generated by the voltage regulation loop of the energy-dense battery pack 104. The input current is prevented from exceeding its rated value through saturation limits, i_{in,E,limit} on the common current reference, i_{ref,comm,E}. The regulation of the average SOC of the power-dense battery pack 106 SOC_{P,avg} is determined by i_{ref,SOC,P}, which is generated by the average SOC regulation loop of the power-dense battery pack 106. The controllers 306, 308, 310 for the energy-dense battery pack 104 and the power-dense battery pack 106 coordinate to modify the common current reference for the BEMs 302 of the power-dense battery pack 106, i_{ref,comm,P} to enhance energy balancing. As shown in FIG. 10, i_{ref,comm,P} is obtained by:

$${i}_{ref , comm , P} = {i}_{ref , SOC , P} - {i}_{ref , ffrec} , \qquad ( 9 )$$

$${i}_{ref , ffrec} = {K}_{rec} ( {i}_{in , E , limit} - {i}_{ref , comm , E} ) , \qquad ( 10 )$$

where i_{ref,ffrec} is the feedforward current and Krec is a scaling factor determining whether recovery is required. Since, |i_{ref,comm,E}|<|i_{in,E,lim}|, the DC-DC converters of the energy-dense battery pack 104 have the capability to deliver the corresponding energy to the power-dense battery pack 106. The control helps to ensure that the energy-dense battery pack's BEMs 304 are utilized to enable the restoration of the pre-assistive mode SOC_{P,avg} trajectory. The current i_{ref,frec} changes dynamically as the load on the LV DC bus changes.

The charge redistribution during the assistive mode, qₐₛₛᵢₛₜᵢᵥₑ and recovery mode, q_{recovery} are given as:

$${q}_{assistive} = \int {i}_{ref , ff , volt} dt , \qquad ( 11 )$$

$${q}_{recovery} = \int {i}_{ref , ff , rec} dt , \qquad ( 12 )$$

In the non-assistive mode, qₐₛₛᵢₛₜᵢᵥₑ and q_{recovery} are zero. However, qₐₛₛᵢₛₜᵢᵥₑ attains a non-zero value during the assistive mode. Once the ETU 102 enters the recovery mode, q_{recovery} also typically attains a non-zero value.

Krec is determined using the value of (|qₐₛₛᵢₛₜᵢᵥₑ|−|q_{recovery}|), such that:

$${K}_{rec} = \{ \begin{matrix}1 ; & ( \vert {q}_{assistive} \vert - \vert {q}_{recovery} \vert ) \neq 0 \\ 0 ; & ( \vert {q}_{assistive} \vert - \vert {q}_{recovery} \vert ) = 0\end{matrix} . \qquad ( 13 )$$

During the non-assistive mode, (|qₐₛₛᵢₛₜᵢᵥₑ|−|q_{recovery}|) is zero and hence Krec is zero. During the assistive mode, (|qₐₛₛᵢₛₜᵢᵥₑ|−|q_{recovery}|) increases, and K_{rec}=1, indicating that the ETU 102 requires charge recovery to ensure that SOC_{P,avg} is rapidly redirected to its desired balancing trajectory. Since the recovery mode proceeds the assistive mode and K_{rec}=1, i_{ref,ff,rec} ensures that q_{recovery} increases in magnitude to counter qₐₛₛᵢₛₜᵢᵥₑ. Eventually, (|qₐₛₛᵢₛₜᵢᵥₑ|−|q_{recovery}|) becomes zero, which ends the recovery mode. The condition for the culmination of the recovery mode is:

$$\vert {q}_{assistive} \vert = \vert {q}_{recovery} \vert . \qquad ( 14 )$$

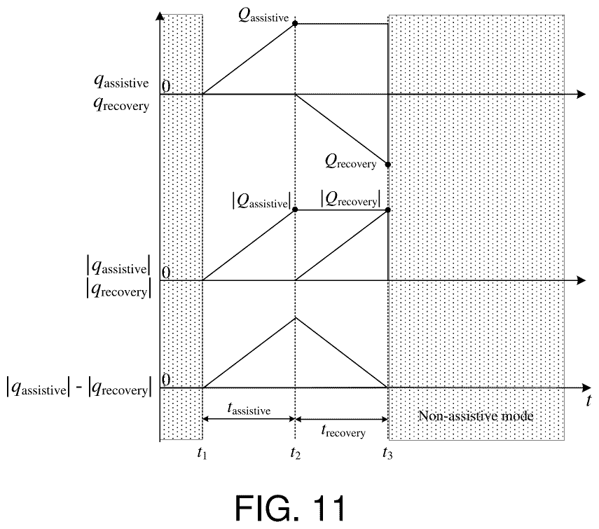

FIG. 11 is a schematic block diagram illustrating charge recovery during recovery mode, according to various embodiments. As shown in FIG. 11, the recovery mode is sustained until the charge redistribution between the two battery packs 104, 106 resulting from the recovery mode denoted as [symbol] _{recovery} attains equivalence to the charge redistribution that occurred during the assistive mode, indicated by [symbol] ₐₛₛᵢₛₜᵢᵥₑ. The interval during which the assistive mode is activated at time t1 where the combined load of the BEMs 304 of the energy-dense battery pack 104 increases beyond their rated power, and deactivated at time t2 where the combined load of the BEMs 304 of the energy-dense battery pack 104 decreases below their rated power is denoted as tₐₛₛᵢₛₜᵢᵥₑ. In contrast, the interval during which the recovery mode is activated at time t2 and deactivated at time t3 is referred to as t_{recovery}. The recovery mode ends when:

$$\vert {Q}_{assistive} \vert = \vert {Q}_{recovery} \vert , \qquad ( 15 )$$

$$where :$$

$${Q}_{assistive} = {\int }_{0}^{{t}_{assistive}} {i}_{ref , ff , volt} dt , \qquad ( 16 )$$

$${Q}_{recovery} = {\int }_{0}^{{t}_{recovery}} {i}_{ref , ff , rec} dt . \qquad ( 17 )$$

Upon the recovery mode's culmination at time t3, and given that the combined load of the BEMs 304 of the energy-dense battery pack 104 remains below their rated power, the BEMs 302 of the power-dense battery pack 103 enter the non-assistive mode.

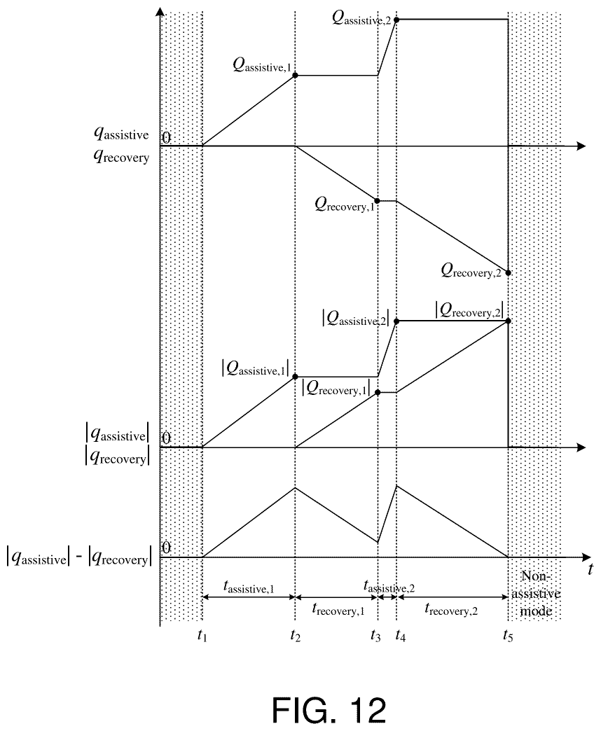

FIG. 12 is a diagram illustrating charge recovery for two overlapping atypical loads, according to various embodiments. FIG. 12 shows a scenario where the second interval of the assistive mode, t_{assistive,2} occurs before t_{recovery,1} can recover the charge, Q_{assistive,1}, such that |Q_{recovery,1}|<|Q_{assistive,1}|. At time t3, the combined load of the BEMs 304 of the energy-dense battery pack 104 increases beyond their rated power, such that the assistive mode is activated and Q_{assistive,2} is accumulated. As the combined load of the BEMs 304 of the energy-dense battery pack 104 again decreases below their rated power, at time t4, the assistive mode ends, and the recovery mode starts. During the recovery mode, the BEMs 302 of the power-dense battery pack 106 have to recover the remaining portion of Q_{assistive,1}, alongside recovering Q_{assistive,2}. Once the cumulative charge from the assistive mode has been recovered and the combined load of the BEMs 304 of the energy-dense battery pack 104 remains below their rated power, the BEMs 302 of the power-dense battery pack 106 enter the non-assistive mode at time t5. The charge redistribution is complete when:

$$\vert {Q}_{recovery} \vert = \vert {Q}_{assistive} \vert , \qquad ( 18 )$$

$$\vert {Q}_{recovery , 1} \vert + \vert {Q}_{recovery , 2} \vert = \vert {Q}_{assistive , 1} \vert + \vert {Q}_{assistive , 2} \vert$$

$$where :$$

$${Q}_{assistive , 1} = {\int }_{0}^{{t}_{assistive , 1}} {i}_{ref , ff , volt} dt , \qquad ( 19 )$$

$${Q}_{assistive , 2} = {\int }_{{t}_{assistive , 1}}^{{t}_{assistive , 2}} {i}_{ref , ff , volt} dt , \qquad ( 20 )$$

$${Q}_{recovery , 1} = {\int }_{0}^{{t}_{recovery , 1}} {i}_{ref , ff , rec} dt , \qquad ( 21 )$$

$${Q}_{recovery , 2} = {\int }_{{t}_{recovery , 1}}^{{t}_{recovery , 2}} {i}_{ref , ff , rec} dt , \qquad ( 22 )$$

The control loop analysis of Section III.A for the non-assistive mode and III.B for the assistive mode remain unaffected as the feedforward dynamics are fast and do not interfere with the feedback control loops.

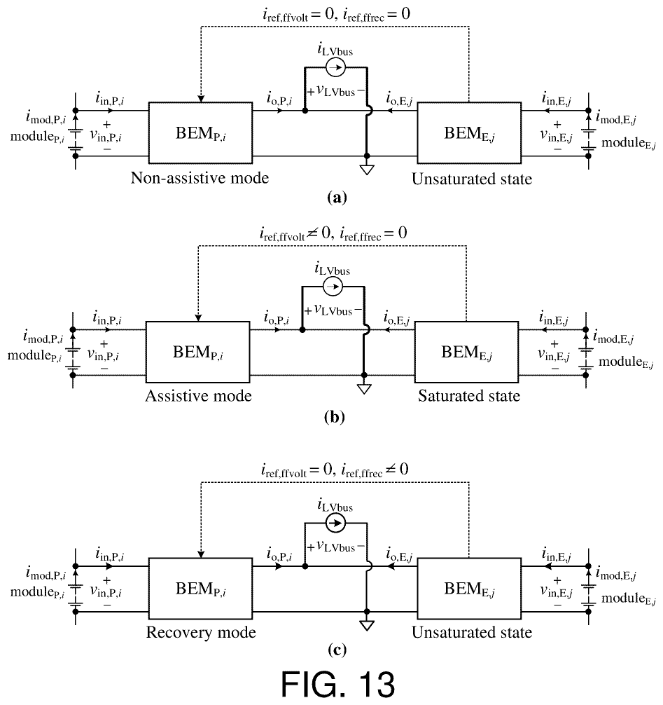

FIG. 13 displays three operating scenarios for the BEMs 302 of the energy-dense battery pack 104 and the power-dense battery pack 106 (BEM_{E,j} 304 and BEM_{P,I} 302). In FIG. 13(a), when the combined power required by the auxiliary load and BEM_{P,I} 302 is below the rated power of BEM_{E,j} 304, BEM_{E,j} 304 operates in an unsaturated state and BEM_{P,I} 302 operates in a non-assistive mode, meaning that iref,comm,E is unsaturated and iiref,ffvolt and iiref,ffrec are zero. However, when the combined power required by the auxiliary load and BEM_{P,I} 302 is higher than the rated power of the DC-DC converter in BEM_{E,j} 304 (as shown in FIG. 13(b)), BEM_{E,j} 304 becomes saturated and BEM_{P,I} 302 switches to an assistive mode, meaning that i_{ref,comm,E} is saturated and i_{ref,ffvolt} becomes non-zero. In this case, the voltage regulation loop dominates the contribution to i_{ref,comm,P} and regulates the LV DC bus voltage. Energy balancing slows down, and i_{ref,ffvrec} is also zero. In FIG. 13(c), when the combined power required by the auxiliary load and BEM_{P,I} 302 reverts to being below the rated power of BEM_{E,j} 304, BEM_{E,j} 304 operates in an unsaturated state and BEM_{P,I} 302 operates in a recovery mode, meaning that i_{ref,comm,E} is unsaturated, i_{iref,ffvolt} is zero and i_{ref,ffrec} is non-zero. In this case, feedforward terms help to ensure that SOC_{P,avg} regains its pre-assistive mode trajectory of energy balancing.

In some embodiments, the current i_{ref,ffrec} is derived from i_{in,E,lim}, and is dependent on the voltage regulation loop compensator and supplements the average SOC regulation loop, which helps to ensure steady-state and transient voltage and transient average SOC regulation remain unchanged. By virtue of their operation in the recovery mode, the BEMs 302 of the power-dense battery pack 106 prioritize the acceleration of energy balancing between the two battery packs.

Returning to FIG. 9, what is illustrated are the variations in LV DC bus voltage and the average SOC for the power-dense battery pack 106 SOC_{P,avg} in the absence and presence of the assistive and recovery modes. At time t1, the combined load on BEM_{E,j} 304 increases beyond its rated power. Without the assistive mode, LV DC bus voltage decreases and is no longer regulated at the desired setpoint. At time t2, the combined load on BEM_{E,j} 304 decreases below its rated power, and LV DC bus voltage returns to being regulated at the desired setpoint. SOC_{P,avg} is well-regulated at its setpoint, as the power-dense battery pack 106 does not deliver energy to the auxiliary loads.

With the assistive mode, even as the combined load on BEM_{E,j} 304 increases beyond its rated power at time t1, LV DC bus voltage remains well-regulated around the desired setpoint. SOC_{P,avg} decreases until reaching time t2 as the power-dense battery pack 106 delivers energy to the auxiliary loads. At time t2, the combined load on BEM_{E,j} 304 decreases below its rated power, and the system 100, 200, 300 returns to the non-assistive mode. SOC_{P,avg} gradually returns to its desired setpoint at time t4. The utilization of the power-dense battery pack 106 arises when the auxiliary power demand surpasses the designated capacity of the auxiliary power system 110. During regular operational circumstances, the power-dense battery pack 106 does not serve the purpose of powering auxiliary loads. This restraint prevents energy consumption from the power-dense battery pack 106 and the subsequent decline in SOC_{P,avg}.

With the assistive and recovery mode, the operation of the ETU 102 up until time t2 remains similar. In the absence of the recovery mode, the ETU 102 requires an interval of time t2 to time t4 for SOC_{P,avg} to return to its setpoint. However, the inclusion of the recovery mode shortens this interval as SOC_{P,avg} reaches its setpoint at time t3. This observation suggests that the recovery mode also assists in balancing the energy in the system.

### IV. EXPERIMENTAL RESULTS

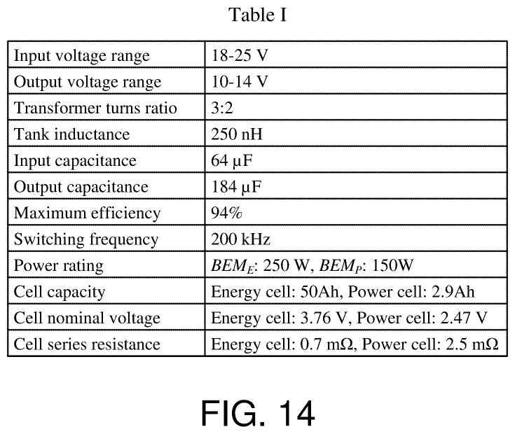

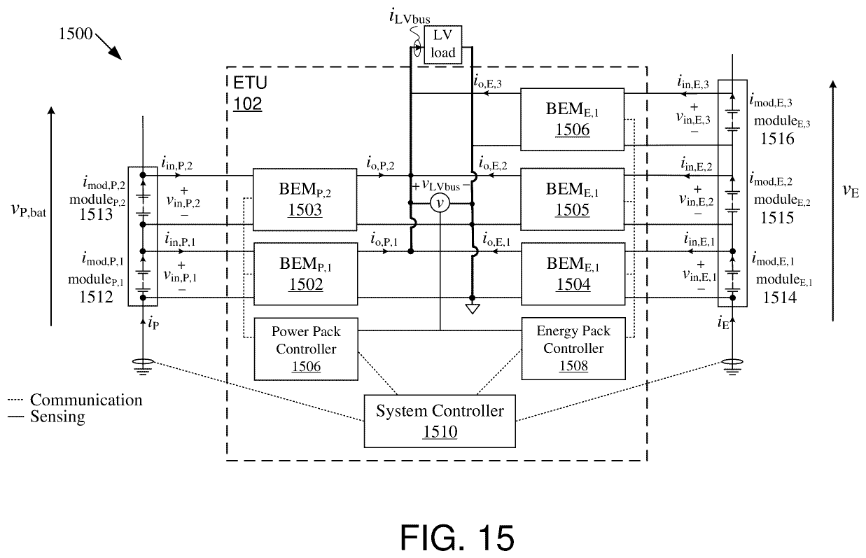

FIG. 15 is a diagram illustrating a control diagram of a system 1500 for SOC of a battery cell versus average battery SOC for a battery pack, according to various embodiments. The proposed multi-mode control strategy with feedforward control has been validated using an experimental setup depicted in FIG. 15. The setup comprises five cell modules 1512, 1513, 1514, 1515, 1516. Two cell modules 1512 and 1513, each consisting of eight series-connected LTO cells with a capacity of 2.9 Ah are connected to BEM_{P,1} 1502 and BEM_{P,2} 1503, which are equipped with 150 W isolated dual active bridge (“DAB”) converters. Three cell modules 1514, 1515, 1516, each including six NMC cells with a capacity of 50 Ah are connected to BEM_{E,1} 1504, BEM_{E,2} 1505, and BEM_{E,3} 1506, which are equipped with 250 W isolated DAB converters. The choice of utilizing DAB converters with phase-shift modulation control for the bidirectional DC-DC converter topology in the BEMs 1502, 1503, 1504, 1505, 1506, stems from considerations of system requirements such as efficiency and isolation. The converter parameters are summarized in Table I, on FIG. 14.

The experimental setup schematic is depicted in FIG. 15. In this setup, input current control for each converter (BEM_{P,1} 1502, BEM_{P,2} 1503, BEM_{E,1} 1504, BEM_{E,2} 1505, BEM_{E,3} 1506) is implemented locally, while a pack controller (1507, 1508, 1510) is employed to govern the regulation loops for the LV DC bus voltage and average SOC. The input current regulation loops possess different bandwidths, specifically 1 kHz and 100 Hz, for the DC-DC converters in the BEMs 1502, 1503, 1504, 1505, 1506 within the energy-dense battery pack 1514, 1515, 1516 and power-dense battery pack 1512, 1513. Meanwhile, the auxiliary DC bus voltage regulation loop operates at a frequency of 100 Hz, and the average SOC regulation loop operates at a frequency of 1 mega Hertz (“mHz”). To evaluate the performance of the ETU 102 across various operational scenarios, a DC electronic load is connected to the LV DC bus. By modifying the current, denoted as i_{LV_bus}, the performance of the ETU 102 is observed under different conditions.

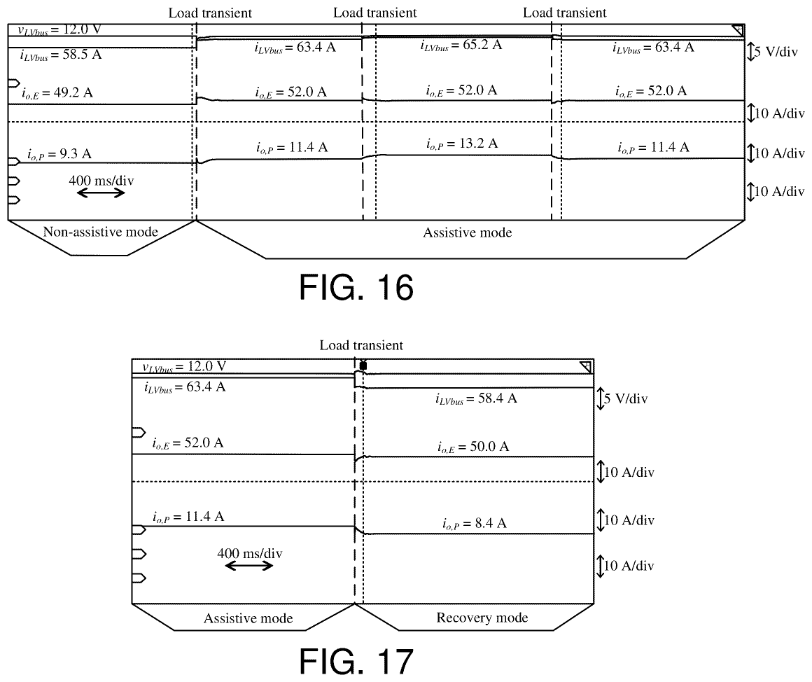

The proposed feedforward control strategy results are displayed in FIGS. 16-21. The LV DC bus voltage and average SOC regulation loops are enabled within the ETU 102. It should be noted that in the provided figures, positive current values indicate the discharging of cells, while negative current values signify the charging of cells.

### A. Power-Dense BEMs in Discharging State

FIG. 16 depicts a closed-loop response of the hardware setup 1500 when the converters of the ETU 102 transition from the non-assistive to assistive mode during discharging of the power-dense cells 1512, 1513. FIG. 16 demonstrates smooth transitions in the performance of BEM_{E}s 1504, 1505, 1506 and BEM_{P}s 1502, 1503 as they transition from the non-assistive to assistive mode as the load increases from i_{LV bus}=58.5 A to 63.4 A. The input current regulation of the BEM_{E}s 1504, 1505, 1506 saturates as the load increases, and i_{o,E} changes from 49.2 A to its limit of 52.0 A. The BEM_{E}S 1504, 1505, 1506 can no longer deliver the required LV DC bus load while the BEM_{P}s 1502, 1504 are discharging. As a result, the system 1500 enters the assistive mode, and the BEM_{P}s 1502, 1503 deliver the remaining power to the load. The current i_{o,P} increases from 9.3 A to 11.4 A. The stable transition reflects the stable transient performance. It is shown that when in assistive mode, the output current of the BEM_{P}s 1502, 1503 increase so that power can be delivered to the LV load. During assistive mode, the output current of BEM_{P}s 1502, 1503 increases from 11.4 A to 13.2 A as i_{LV bus} increases from 63.4 A to 65.2 A, but i_{o,E} remains constant at 52.0 A. Similarly, the output current of BEM_{P}s 1502, 1503 decreases from 13.2 A to 11.4 A as i_{LV bus} decreases from 65.2 A to 63.4 A, but i_{o,E} remains constant at 52.0 A.

FIG. 17 depicts a closed-loop response of the hardware setup 1500 when the converters of the ETU 102 transition from the assistive to recovery mode during discharging of the power-dense cells 1512, 1513, according to various embodiments. FIG. 17 shows smooth transitions in the performance of BEM_{E}s 1504, 1505, 1506 and BEM_{P}s 1502, 1504 as they transition from the assistive to the recovery mode as the load decreases from i_{LV bus}=63.4 A to 58.4 A. The input current regulation of the BEM_{E}S 1504, 1505, 1506 is no longer saturated, and i_{o,E} decreases from 52.0 A to 50.0 A. However, it is necessary to recover the energy that was delivered by the BEM_{P}s 1502, 1503. Therefore, the output current of the BEM_{P}s 1502, 1503 is lower than it was in the non-assistive mode, and i_{o,E} is greater than it was initially in the non-assistive mode. The current i_{o,P} changes from 11.4 A to 8.4 A as BEM_{P}s 1502, 1503 begin to discharge at a slower rate. The stable transition reflects the stable transient performance.

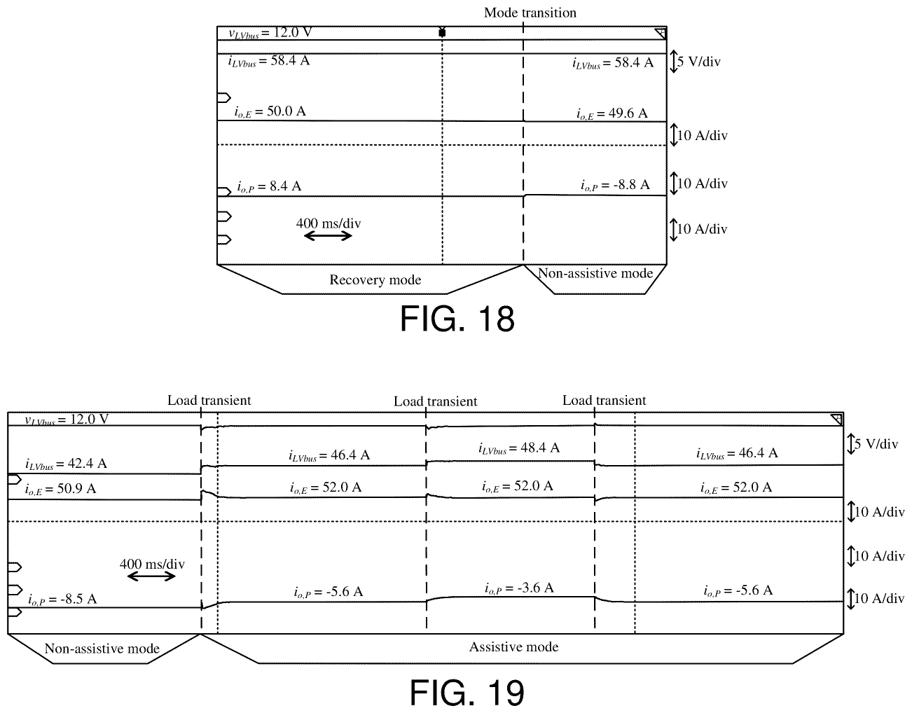

FIG. 18 depicts a closed-loop response of the hardware setup 1500 when the converters of the ETU 102 transition from the recovery to non-assistive mode during discharging of the power-dense cells 1512, 1513, according to various embodiments. FIG. 18 depicts smooth transitions in the performance of BEM_{E}S 1504, 1505, 1506 and BEM_{P}s 1502, 1503 as they transition from the recovery mode to the non-assistive mode and the load remains constant. The BEM_{P}s 1502, 1503 have reverted to their original energy balancing trajectory, and thus, their output current increases to 8.8 A from 8.4 A. The BEM_{E}S 1504, 1505, 1506 output current decreases from 50.0 A to 49.6 A. The stable transition reflects the stable transient performance.

FIG. 19 depicts a closed-loop response of the hardware setup 1500 when the converters of the ETU 102 transition from the non-assistive to assistive mode during charging of the power-dense cells 1512, 1513, according to various embodiments. FIG. 19 demonstrates smooth transitions in the performance of BEM_{E}S 1504, 1505, 1506 and BEM_{P}s 1502, 1503 as they transition from the non-assistive to assistive mode as the load increases from i_{LV bus}=42.4 A to 46.4 A. The input current regulation of the BEM_{E}S 1504, 1505, 1506 saturates as the load increases, and i_{o,E} changes from 50.9 A to its limit of 52.0 A. BEM_{E}S 1504, 1505, 1506 can no longer deliver the required LV DC bus load while the BEM_{P}s 1502, 1503 are charging. As a result, the system enters the assistive mode. The current i_{o,P} increases from −8.5 A to −5.6 A. The stable transition reflects the stable transient performance. It is shown that when in assistive mode, the BEM_{P}s 1502, 1503 output current decreases in magnitude if the load current increases and increases in magnitude if the load current decreases. During assistive mode, the output current of BEM_{P}s 1502, 1503 increases from −5.6 A to −3.6 A as i_{LV bus} increases from 46.4 A to 48.4 A, but i_{o,E} remains constant at 52.0 A. Similarly, the output current of BEM_{P}s 1502, 1503 decreases from −3.6 A to −5.6 A as i_{LV bus} decreases from 48.4 A to 46.4 A, but i_{o,E} remains constant at 52.0 A. However, the output current of BEM_{E}S 1504, 1505, 1506 remains constant.

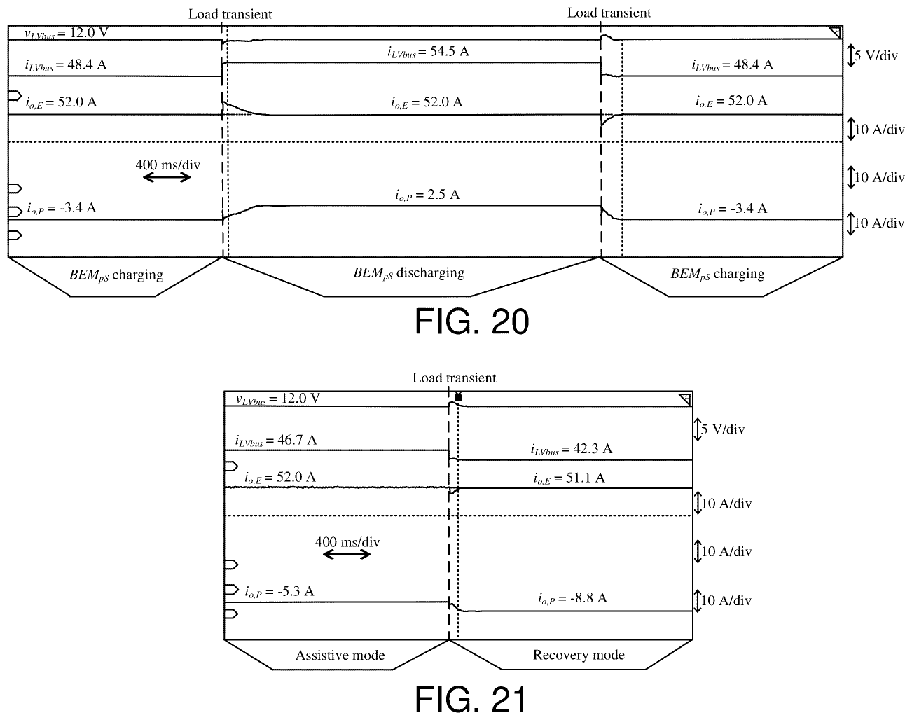

FIG. 20 depicts a closed-loop response of the hardware setup 1500 when the converters of the ETU 102 transition from charging to discharging to charging during the assistive mode, according to various embodiments. FIG. 20 presents the results during assistive mode when the load current increases causing the power-dense pack to switch from charging to discharging. As i_{LV bus} increases from 48.4 A to 54.5 A, i_{o,E} remains constant at 52.0 A but i_{o,P} changes from −3.4 A to 2.5 A. The power-dense pack cells revert to charging when the load decreases. As i_{LV bus} decreases from 54.5 A to 48.4 A, i_{o,E} remains constant at 52.0 A but i_{o,P} changes from 2.5 A to −3.4 A. The results demonstrate that the LV DC bus is efficiently regulated at 12 V.

FIG. 21 depicts a closed-loop response of the hardware setup 1500 when the converters of the ETU 102 transition from the assistive to recovery mode during charging of the power-dense cells 1512, 1513, according to various embodiments. FIG. 21 shows smooth transitions in the performance of BEM_{E}S 1504, 1505, 1506 and BEM_{P}s 1502, 1503 as they transition from the assistive to the recovery mode as the load decreases from i_{LV bus}=46.7 A to 42.3 A. The input current regulation of the BEM_{E}s 1504, 1505, 1506 is no longer saturated, and i_{o,E} decreases from 52.0 A to 51.1 A. However, it is necessary to recover the energy that was delivered by the BEM_{P}s 1502, 1503. Therefore, the output current of the BEM_{P}s 1502, 1503 increases in magnitude more than it was in the non-assistive mode, and i_{o,E} is greater than it was initially in the non-assistive mode. The current i_{o,P} changes from −5.3 A to −8.8 A as BEM_{P}s 1502, 1503 begins to charge faster. The stable transition reflects the stable transient performance.

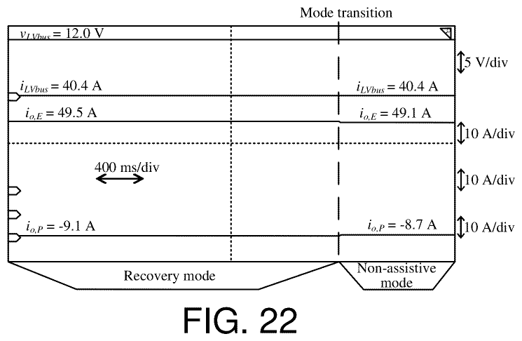

FIG. 22 depicts a closed-loop response of the hardware setup 1500 when the converters of the ETU 102 transition from the recovery to non-assistive mode during charging of the power-dense cells 1512, 1513, according to various embodiments. FIG. 22 depicts smooth transitions in the performance of BEM_{E}S 1504, 1505, 1506 and BEM_{P}s 1502, 1503 as they transition from the recovery mode to the non-assistive mode, and the load remains constant at 40.4 A. The BEM_{P}s 1502, 1503 have reverted to their original energy balancing trajectory, and thus, their output current decreases in magnitude to −8.7 A from −9.1 A. The BEM_{E}S 1504, 1505, 1506 output current decreases from 49.5 A to 49.1 A. The stable transition reflects the stable transient performance.

The proposed multi-mode control strategy implemented within the energy transfer unit (“ETU”) 102 of a hybrid battery energy storage system uses feedforward control to regulate the electric vehicle (“EV”)'s low-voltage (“LV”) auxiliary direct current (“DC”) bus under high dynamic or heavy auxiliary loads. The control strategy was seamlessly integrated with the LV DC bus voltage and average state-of-charge regulation feedback control loops of the hybrid battery system, allowing the auxiliary power system to accommodate intermittent loads effectively. The 1.1 kW prototype ETU 102 comprising isolated dual-active-bridge (“DAB”) converters and a 12 V LV DC bus validated the efficacy of the proposed control strategy, showcasing its superior performance across a range of diverse load conditions. The proposed control strategy has the potential to be widely adopted in the EV industry, leading to improved battery management.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An energy transfer unit comprising:
a power-dense direct-current (“DC”)-DC converter for each power-dense battery module of a power-dense battery pack, each power-dense DC-DC converter connected to a power-dense battery module of the power-dense battery pack and to an auxiliary bus providing power to an auxiliary load;
an energy-dense DC-DC converter for each energy-dense battery module of an energy-dense battery pack, each energy-dense DC-DC converter connected to an energy-dense battery module of the energy-dense battery pack and to the auxiliary bus; and
an energy balance circuit configured to:
maintain an average state-of-charge (“SOC”) of the power-dense battery pack at a SOC setpoint;
regulate voltage of the auxiliary bus; and
control each energy-dense battery module of the energy-dense battery pack, wherein the energy balance circuit draws power from the energy-dense battery pack to maintain the average SOC of the power-dense battery pack.

2. The energy transfer unit of claim 1, wherein the energy balance circuit comprises:
a voltage compensation loop configured to regulate the voltage of the auxiliary bus to an auxiliary bus setpoint, the voltage compensation loop providing an energy-dense current reference to each of the energy-dense DC-DC converters; and
an average SOC compensation loop configured to regulate the average SOC of the power-dense battery pack to the SOC setpoint, the average SOC compensation loop providing a power-dense current reference to each of the power-dense DC-DC converters.

3. The energy transfer unit of claim 1, further comprising an assistive mode circuit configured to, during an assistive mode, provide power to the auxiliary load in response to the auxiliary load comprising an atypical load that exceeds a power limit of the energy-dense battery pack, wherein the assistive mode circuit overrides the energy balance circuit to allow the average SOC of the power-dense battery pack to decrease below the SOC setpoint.

4. The energy transfer unit of claim 3, wherein the energy balance circuit comprises an energy-dense upper current limit for the energy-dense battery pack and wherein the assistive mode circuit comprises a current feedforward loop configured to, during the assistive mode, override the average SOC compensation loop maintaining the average SOC of the power-dense battery pack in response to current from the energy-dense battery pack exceeding the energy-dense upper current limit, the assistive mode circuit configured to lower the average SOC of the power-dense battery pack by modifying a power-dense current reference to each power-dense DC-DC converter.

5. The energy transfer unit of claim 3, further comprising a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit, wherein the rapid recovery circuit overrides the assistive mode circuit during the recovery mode.

6. The energy transfer unit of claim 5, wherein the rapid recovery circuit comprises a recovery feedforward loop configured to, during the recovery mode, override the assistive mode circuit and to increase the average SOC of the power-dense battery pack to a SOC in compliance with the SOC setpoint by modifying a power-dense current reference to each of the power-dense DC-DC converters.

7. The energy transfer unit of claim 3, further comprising a shutdown circuit configured to monitor an overall SOC of the power-dense battery modules and the energy-dense battery modules and to send a shutdown signal to each of the power-dense DC-DC converters and the energy-dense DC-DC converters in response to the overall SOC reaching an overall SOC minimum threshold, the shutdown signal causing the power-dense DC-DC converters and the energy-dense DC-DC converters to stop providing power to the auxiliary load.

8. The energy transfer unit of claim 1, wherein each of the energy-dense DC-DC converters isolates each of the energy-dense battery modules from the auxiliary bus and each of the power-dense DC-DC converters isolates each of the power-dense battery modules from the auxiliary bus.

9. The energy transfer unit of claim 8, wherein each of the energy-dense DC-DC converters and each of the power-dense DC-DC converters have a dual active bridge converter topology.

10. The energy transfer unit of claim 1, wherein each of the power-dense battery modules of the power-dense battery pack is connected in series and the power-dense battery pack is connected in series with a capacitor, wherein the power-dense battery pack and the capacitor are connected to a high-voltage bus providing power to a high-voltage load, and wherein each of the energy-dense battery modules of the energy-dense battery pack is connected in series and terminals of the energy-dense battery pack are connected in parallel with the power-dense battery pack and capacitor on the high-voltage bus, the high-voltage bus comprising a bus voltage higher than a bus voltage of auxiliary bus.

11. The energy transfer unit of claim 1, wherein each of the power-dense battery modules of the power-dense battery pack is optimized for proving current during transient load conditions and wherein each of the energy-dense battery modules of the energy-dense battery pack is optimized to have a high amount of available energy over a wide discharge power range.

12. The energy transfer unit of claim 1, wherein the power-dense battery modules of the power-dense battery pack have a higher specific power than the energy-dense battery modules of the energy-dense battery pack and wherein the energy-dense battery modules of the energy-dense battery pack have a higher specific energy than the power-dense battery modules of the power-dense battery pack.

13. A composite hybrid energy-storage system comprising:
a plurality of power-dense battery modules in a power-dense battery pack;
a plurality of energy-dense battery modules in an energy-dense battery pack;
an auxiliary bus providing power to an auxiliary load;
a power-dense direct-current (“DC”)-DC converter for each power-dense battery module of the power-dense battery pack, each power-dense DC-DC converter connected to a power-dense battery module of the power-dense battery pack and to the auxiliary bus;
an energy-dense DC-DC converter for each energy-dense battery module of the energy-dense battery pack, each energy-dense DC-DC converter connected to the energy-dense battery module of the energy-dense battery pack and to the auxiliary bus; and
an energy balance circuit configured to:
maintain an average state-of-charge (“SOC”) of the power-dense battery pack at a SOC setpoint;
regulate voltage of the auxiliary bus; and
control each energy-dense battery module of the energy-dense battery pack,
wherein the energy balance circuit draws power from the energy-dense battery pack to maintain the average SOC of the power-dense battery pack.

14. The composite hybrid energy-storage system of claim 13, wherein the energy balance circuit comprises:
a voltage compensation loop configured to regulate the voltage of the auxiliary bus to an auxiliary bus setpoint, the voltage compensation loop providing an energy-dense current reference to each of the energy-dense DC-DC converters; and
an average SOC compensation loop configured to regulate the average SOC of the power-dense battery pack to the SOC setpoint, the average SOC compensation loop providing a power-dense current reference to each of the power-dense DC-DC converters.

15. The composite hybrid energy-storage system of claim 13, further comprising an assistive mode circuit configured to, during an assistive mode, provide power to the auxiliary load in response to the auxiliary load comprising an atypical load that exceeds a power limit of the energy-dense battery pack, wherein the assistive mode circuit overrides the energy balance circuit to allow the average SOC of the power-dense battery pack to decrease below the SOC setpoint.

16. The composite hybrid energy-storage system of claim 15, further comprising a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit, wherein the rapid recovery circuit overrides the assistive mode circuit during the recovery mode.

17. The composite hybrid energy-storage system of claim 13, wherein each of the energy-dense DC-DC converters isolates each of the energy-dense battery modules from the auxiliary bus and each of the power-dense DC-DC converters isolates each of the power-dense battery modules from the auxiliary bus.

18. The composite hybrid energy-storage system of claim 13, further comprising a capacitor and a high-voltage bus providing power to a high-voltage load, wherein each of the power-dense battery modules of the power-dense battery pack is connected in series and the power-dense battery pack is connected in series with the capacitor, wherein the power-dense battery pack and the capacitor are connected to the high-voltage bus, and wherein each of the energy-dense battery modules of the energy-dense battery pack is connected in series and terminals of the energy-dense battery pack are connected in parallel with the power-dense battery pack and capacitor on the high-voltage bus, the high-voltage bus comprising a bus voltage higher than a bus voltage of auxiliary bus.

19. An energy transfer unit comprising:
a power-dense direct-current (“DC”)-DC converter for each power-dense battery module of a power-dense battery pack, each power-dense DC-DC converter connected to a power-dense battery module of the power-dense battery pack and to an auxiliary bus providing power to an auxiliary load;
an energy-dense DC-DC converter for each energy-dense battery module of an energy-dense battery pack, each energy-dense DC-DC converter connected to an energy-dense battery module of the energy-dense battery pack and to the auxiliary bus;
an energy balance circuit configured to:
maintain an average state-of-charge (“SOC”) of the power-dense battery pack at a SOC setpoint;
regulate voltage of the auxiliary bus; and
control each energy-dense battery module of the energy-dense battery pack,
wherein the energy balance circuit draws power from the energy-dense battery pack to maintain the average SOC of the power-dense battery pack;
an assistive mode circuit configured to, during an assistive mode, provide power to the auxiliary load in response to the auxiliary load comprising an atypical load that exceeds a power limit of the energy-dense battery pack, wherein the assistive mode circuit overrides the energy balance circuit to allow the average SOC of the power-dense battery pack to decrease below the SOC setpoint; and
a rapid recovery circuit configured to, during a recovery mode following the assistive mode when power to the auxiliary load is below the power limit of the energy-dense battery pack, provide power to the power-dense battery modules of the power-dense battery pack at a rate higher than provided by the energy balance circuit, wherein the rapid recovery circuit overrides the assistive mode circuit during the recovery mode.

20. The energy transfer unit of claim 19, wherein each of the power-dense battery modules of the power-dense battery pack are connected in series and the power-dense battery pack is connected in series with a capacitor, wherein the power-dense battery pack and the capacitor are connected to a high-voltage bus providing power to a high-voltage load, and wherein each of the energy-dense battery modules of the energy-dense battery pack is connected in series and terminals of the energy-dense battery pack are connected in parallel with the power-dense battery pack and capacitor on the high-voltage bus, the high-voltage bus comprising a bus voltage higher than a bus voltage of auxiliary bus.
